(19) United States
(12) Patent Application Publication
(10) Pub. No.: US 2006/0192506 A1
(43) Pub. Date: Aug. 31, 2006

(54) Ride-on product motor control PCB

(76) Inventors: Donald Miffit, Chelmsford, MA (US); Albert Marcel Larose, Dracut, MA (US); Arthur Aaron, Arlington, MA (US); Scott Keller, Still River, MA (US)

Correspondence Address: BARNES & THORNBURG LLP, Suite 900, 750 17th Street, NW, Washington, DC, 20006-4607, US

(21) Appl. No.: 11/151,203

(22) Filed: Jun. 14, 2005

Related U.S. Application Data
(60) Provisional application No. 60/656,989, filed on Feb. 28, 2005.

(51) Int. Cl. H02P 5/00

(52) U.S. Cl. 318/55

(57) ABSTRACT

A ride-on toy vehicle including an on/off input device, a direction input device and a speed input device. A pair of electrical motors are connected by a switching circuit to the battery in parallel or in series based on the speed input from the speed input device and in a first or second polarity based on the direction input from the direction input device.

### CROSS REFERENCE

This application claims benefit of U.S. provisional patent application Ser. No. 60/656,989, filed Feb. 28, 2005 which is incorporated herein by reference.

### BACKGROUND

The present disclosure relates generally to electrically-powered vehicles and, more specifically, to an electrically-powered toy vehicle.

Electrically-powered toy vehicles generally include a battery power source to drive D.C. motors. Simple circuits use switches to change the speed by connecting two motors in series or in parallel and/or with series impedances. The control systems have become very sophisticated and complicated. These include variations of power cycles with either pulse width modulation or duty cycling, wherein the timing of fixed width pulses is varied. This not only increases the cost but introduces possible points of failure.

### SUMMARY

The presently disclosed ride-on toy vehicle includes an on/off input device, a direction and speed input device. A pair of electrical motors are connected by a switching circuit to the battery. The switches connect the motors to the battery in parallel or in series based on the speed input from the direction and speed input device. It also connects the electric motors to the battery in a first or second polarity based on the direction input from the direction and speed input device. An electrical controller receives the speed input and the direction input and provides switching outputs to the switching circuit. The switching circuit includes four switches whose positions are controlled by the switching outputs of the controller. The first and second switches are connected to the terminals of the first motor, and the third and fourth switches are connected to the terminals of the second motor.

Whereas the first and fourth switches determine the polarity of the motors, the second and third switches determine the parallel/series connection. When in the off position, the four switches disconnect the battery from the motors and connects the motors to ground. The first switch, when on, connects the motors to the battery of a first polarity, and the fourth switch, when on, connects the motors to the battery in a second polarity. The second and third switches in an off position determine the series connection and in an on position determine the parallel connection. The four switches each are part of a separate relay.

This disclosure is also directed to a ride-on toy vehicle having on/off input, direction and speed input device. The electrical motors are connected by a switching circuit to the battery in parallel or in series based on the speed input or in a first and second polarity based on the direction input. The electrical controller receives the speed input and the direction input and provides switching outputs to the switching circuit. The switching circuit is in an off state disconnecting the motors from the battery and connecting the motors to ground for a deactivation state of the on/off input device. The vehicle also includes an accelerator input device connected in series with the on/off input device between the battery and the switching circuit. Both the accelerometer and the on/off input device must be activated for the switching circuit to be responsive to the switching outputs of the controller.

The present disclosure is also directed to a ride-on vehicle having a direction and speed input device. A pair of electrical motors are connected by a switching circuit to a battery in parallel or in series based on the speed input and in a first or second polarity based on the direction input. An electric controller receives the speed and direction input signals and provides switching outputs to the switching circuit. The switching circuit in an off state disconnects the motors from the battery. A current sensor senses the current in the motors and provides the sensed current to the controller. The controller provides switching signals to switch the switching circuit to an off state for an over-current value of the sensed motor current. The switching circuit switches between off and on states until the over-current subsides or for a predetermined number of cycles. The off period of the cycle may be increased if the over-current persists for a pre-selected number of cycles. The over-current should exist for a pre-selected period before the controller starts the cycle.

The present disclosure is further directed to a ride-on toy vehicle having an accelerator input and a direction and speed input device. A pair of electrical motors are connected by a switching circuit to a battery in parallel or in series based on the speed input and in a first and second polarity based on the direction input. An electric controller receives speed input and direction input and provides output signals to the switching circuit. For a high speed input, the controller provides outputs to the switching circuit to connect the motors first in series and then in parallel with the battery for a change of input from a zero speed to a high speed input and to connect the motors first in series with the battery and then off for a change of input from a high speed to a zero speed input.

The present disclosure is further directed to a ride-on toy vehicle having a direction and speed input device. A pair of electrical motors are connected by a switching circuit to a battery in parallel or in series based on the speed input and in a first and second polarity based on the direction input. An electric controller receives speed input and direction input and provides output signals to the switching circuit. The switching circuit includes four switches each having a separate relay coil and whose positions are controlled by the switching outputs of the controller. The first and second switches are connected to the terminals of a first motor and third and fourth switches are connected to the terminals of a second motor. A switch sensor connected to the controller and to at least three of the four switches senses the on/off state of the at least three switches. The controller provides switching signals to switch the at least three switches to an off state and determines a fault if the sensed state of any of the at least three switched is an on state.

These and other aspects of the present disclosure will become apparent from the following detailed description of the disclosure, when considered in conjunction with accompanying drawings.

### BRIEF DESCRIPTION OF THE DRAWINGS

FIG. 1 is a perspective view of a ride-on toy vehicle.

FIG. 2 is a block diagram of the electronics of a ride-on toy vehicle, according to the present disclosure.

FIGS. 3A and 3B are a detailed schematic of the electronics of a toy vehicle, according to the present disclosure.

FIG. 4 is a graph of signals of the schematics of FIGS. 2 and 3 showing direction and speed change.

FIG. 5 is a graph of signals of the schematics of FIGS. 2 and 3 for over-current conditions at low and high speed.

FIG. 6 is a detailed schematic of another embodiment of a controller, according to the present disclosure.

### DETAILED DESCRIPTION

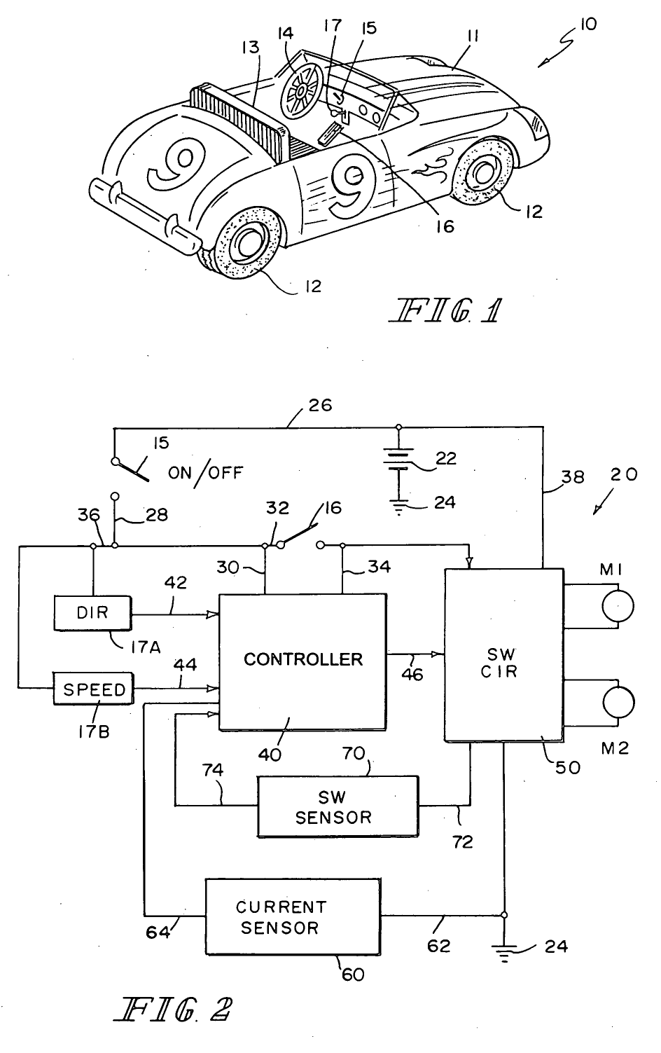

A ride-on toy vehicle 10 is illustrated in FIG. 1. It includes a body 11 having four wheels 12 and a seat 13. It also includes a steering wheel 14, an on/off or ignition switch 15 and an accelerator or gas pedal 16. A single direction and speed input device 17 may be provided. This will allow high and low speeds, as well as forward and reverse. Device 17 may also be two inputs—one for direction, and the other for speed. Also, the speed may be more than just high and low. The toy vehicle 10 is battery operated and includes one or more D.C. motors.

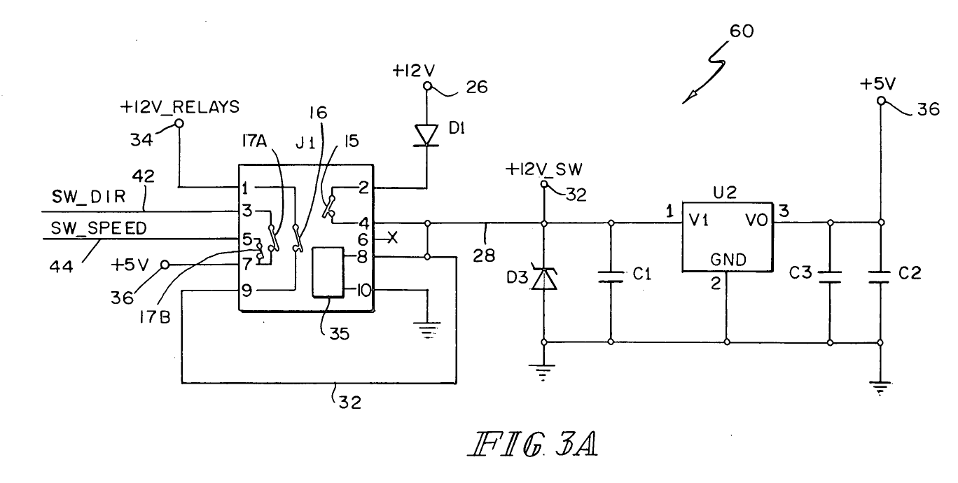

The electrical drive circuit is illustrated in FIG. 2. A battery 22 is connected to ground 24. The positive terminal of battery 22 is connected by line 26 to the on/off or ignition switch 15. The other side of the on/off or ignition switch 15 is connected via lines 28 and 30 to the controller 40. Line 28 is also connected through line 32 to the accelerometer switch 16, which is connected via line 34 to the controller 40 and to the switching circuit 50. Line 28 is also connected through line 36 to the direction input device 17A and the speed input device 17B, which are, in turn, connected by lines 42, 44 to the controller 40. The positive terminal of battery 22 is also connected via line 38 to the switching circuit 50.

The controller 40 receives inputs from the output of switch 16 via line 34 and the direction and speed inputs via lines 42, 44 and provides switching output signals over line(s) 46 to switching circuit 50. Switching circuit 50 controls two motors M1 and M2. It includes switches which control the speed by connecting the motors M1 and M2 in series for low speed and in parallel for high speed. The switching circuit 50 also determines the polarity or the direction in which the motors are rotated and, thereby, the direction of the drive of the wheels 12.

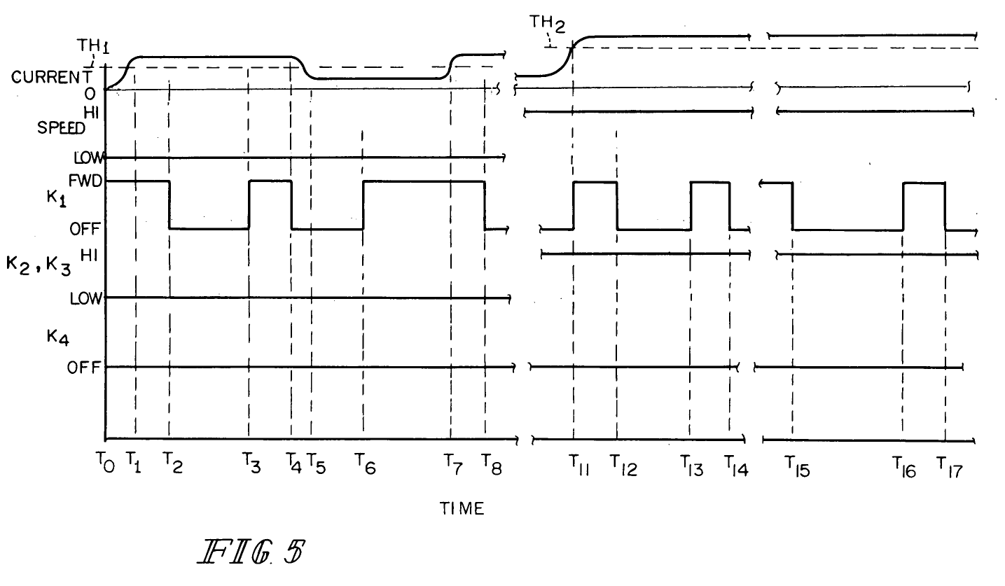

The circuit shown also includes a current sensor 60 connected via line 62 to the switching circuit 50 to sense the current through the motors. The output 64 for the current sensor 60 is provided to the controller 40. The controller 40 determines whether the sensed current is above a threshold. There is a higher threshold for when the motors are in parallel as compared to the threshold when the motors are in series. As will be explained with respect to FIG. 5, the controller 40 provides switching signals on 46 to the switching circuit 50 to disconnect the power from the motors for a brief period of time for a determined over-current. If the over-current persists past the shutdown period, the controller 40 cycles the power to the motors on/off until the over-current ceases or a predetermined number of cycles. If the over-current persists for a given number of cycles, the controller 40 may increase the off time of the motors for future cycles until the over-current condition ceases. The controller 40 may also require the over-current condition to persist for a pre-determined period before it shuts off the power to the motors.

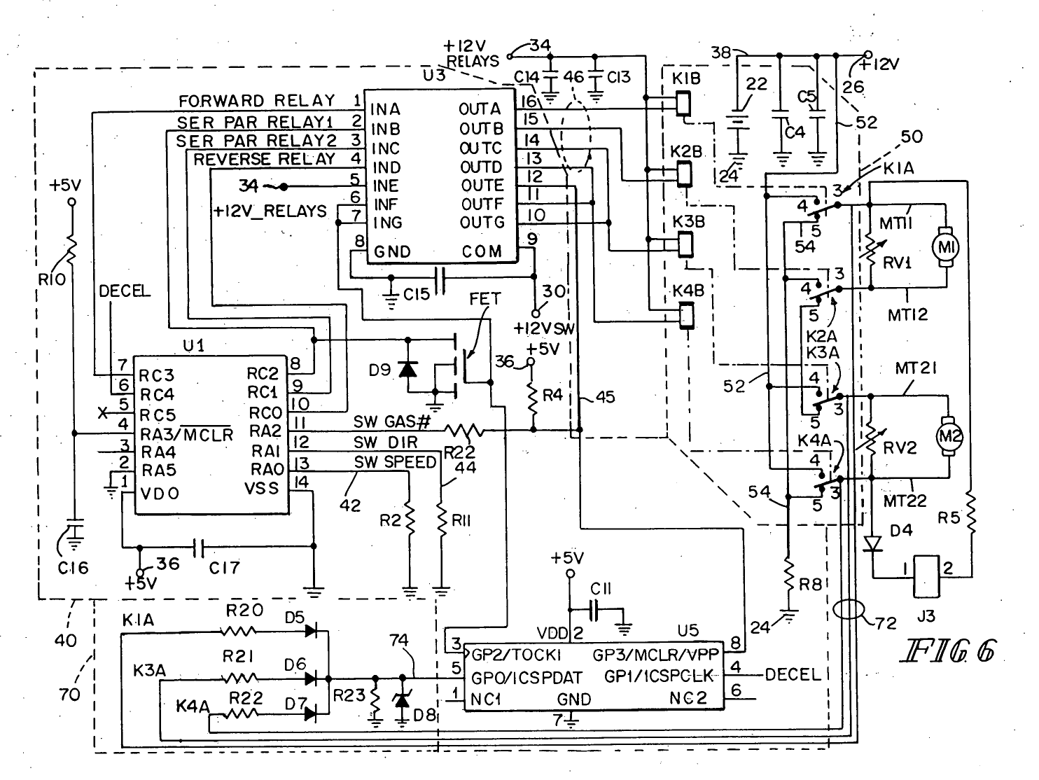

The circuit shown also includes a switch sensor 70 connected via line 72 to the switching circuit 50 to sense the on/off state of one or more of the switches in the switching circuit. The output 74 for the switch sensor 70 is provided to the controller 40. The controller 40 determines if one or more of the switches is in an on state when all of the switches should be in an off state and then declares a fault. If a fault is determined or declared, the controller 40 provides switching signals over 46 to turn one or more of the switches to an off state so as to turn both of the motors M1 and M2 off. The switches can be returned to their off state and checked to see if the fault has cleared. If not and after a predetermined number of cycles, the switches are set into a state which will keep the motors off even if one of the switches is sensed in an on state. A detailed implementation is illustrated in FIG. 6.

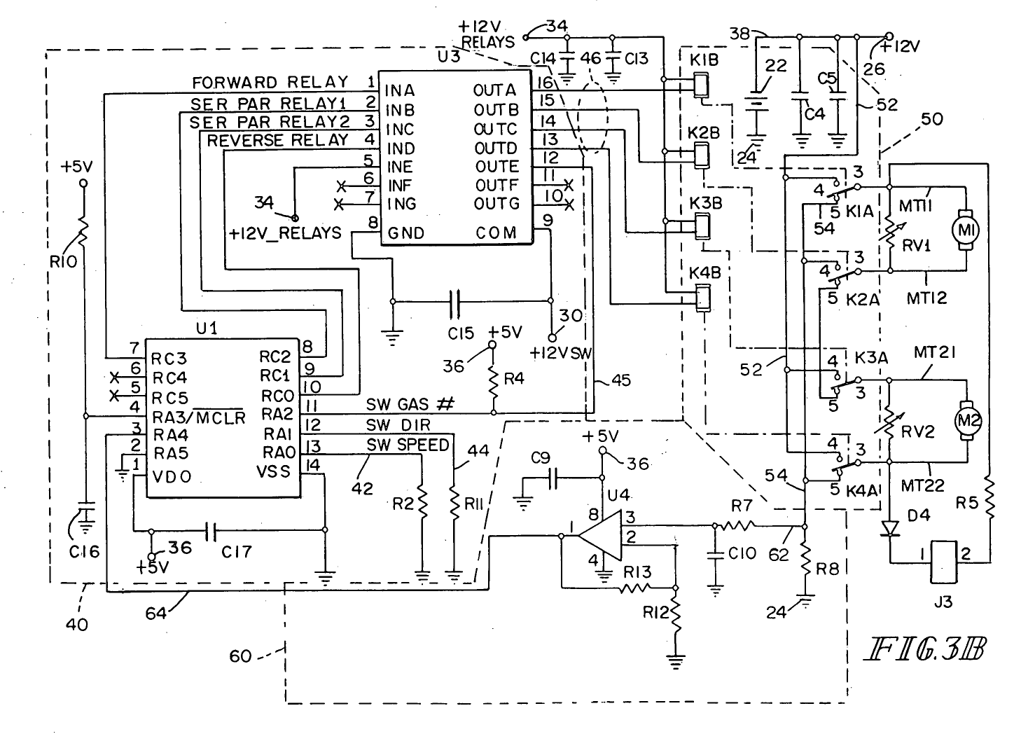

An example of a specific implementation of the circuit of FIG. 2 is illustrated in FIGS. 3A and 3B. The same numbering, where appropriate, has been used in FIGS. 2 and 3A and 3B for consistency as shown in FIG. 3B. The battery 22 is connected at connector J2 to ground 24 and to lead 26. Lead 26 provides a +12V output. Lead 38 connects the positive terminal of the battery to the switching circuit 50. A +12V at 26 is provided as an input through diode D1 to connector J1 at pin 2 of FIG. 3A. The on/off or ignition switch 15 is connected between its pins 2 and 4 and provides an output on 28, which is the 12V SW at 30.

The 12V output at pin 4 is also provided by line 32 to pin 9. Pin 9 is connected to pin 1 by the accelerator switch 16. Line 32 is also connected to pin 8. An auxiliary circuit (for example, an audio port) may be connected between the 12V on pin 8 and ground pin 10. The 12V on line 28 is also provided to a voltage converter U2, which includes input diode D3, capacitor C1 and output capacitors C2, C3. The output provides, for example, a 5V signal 36. Signal 36 is provided as an input on pin 7 of connector J1. The direction input device 17A is connected between pins 7 and 3 to provide an output SW DIR 42 on pin 3. The speed input device 17B is connected between pins 7 and 5 to provide an output SW SPEED 44 on pin 5. These devices may be switches having an open position for forward and a closed position for reverse and having an open position for low speed and a closed position for high speed, respectively. Other kinds of devices may be used.

These signals SW DIR on 42 and SW SPEED on 44 are provided as inputs on pins 13 and 12 of the microprocessor U1 of the controller 40 of FIG. 3B. Pull down resistors R2 and R11 are also connected to pins 13 and 12 respectively. The 12V SW output 30 from line 28 is provided at pin 9 of the inverter U3 of the controller 40. Even though the inverter U3 is shown as being part of the controller 40, it may also be part of the switching circuit 50. A capacitor C15 is connected between pin 9 and ground pin 8 of inverter U3. The 12V RELAY output 34 of connector J1 is provided on pin 5 of inverter U3. The inverted signal from pin 5 is provided as an output on pin 12 and provided via line 45 as the SW GAS # on pin 11 to the microprocessor U1. The application of the 12V RELAY signal at 34 on pin 5 of the inverter U3 produces a grounded output at pin 12, which changes the SW GAS # signal into pin 11 of the microprocessor U1 to ground. This terminal is usually held at a voltage by pull-up resistor R4 along line 45.

Based on the input signals, SW DIR on 42, SW SPEED on 44 and SW GAS # on 45 into the microprocessor U1, the microprocessor U1 provides output FORWARD RELAY on pin 7, series/parallel (SER/PAR) relay output on pins 8 and 9 and a REVERSE RELAY command on pin 10. These are provided respectively on input pins 1, 2, 3 and 4 of the inverter U3. These inputs are inverted and provided on outputs 16, 15, 14 and 13 of U3, respectively, via output 46 to the switching circuit 50.

The other terminals of the microprocessor U1 include the 5V on pin 1 and a capacitor C17 connected between pin 1 and pin 14 of U1. The 5V source is also connected to pin 4 of U1 via resistor R1 and capacitor C16, which is connected to ground. The input on pin 3 is from the current sensor 60, which will be discussed later.

The switching circuit 50 includes four relays, including coils K1B, K2B, K3B and K4B, each controlling single-pole, double-throw switches K1A, K2A, K3A and K4A, respectively. Lead 1 of each of the relay coils K1B-K4B are connected to the 12V relay signal 34 to which is also connected parallel capacitors C13, C14. The other terminal 2 of the relays K1B through K4B is connected to output pins 16, 15, 14 and 13 of the inverter U3. The relay K1 is considered the forward relay, and relay K4 is considered the reverse relay. Relays K2 and K3 are considered the series/parallel relays. In response to high input signals on pins 1, 2, 3 and 4 of U3, appropriate output pins 16, 15, 14 and 13 are grounded which activate the appropriate coils of K1B-K4B. The inverter U3 may be transistor switches, which contain integrated catch diodes to shunt the energy to the 12V supply 12V relays during relay turn off.

Terminal MT11 of motor M1 is connected to terminal 3 of switch K1A, and terminal MT12 of motor M1 is connected to terminal 3 of switch K2A. Terminal MT21 of motor M2 is connected to terminal 3 of switch K3A, and terminal MT22 of motor 22 is connected to terminal 3 of switch K4A. The 12 volts on line 38 connected to the battery is connected via line 52 to terminals 4 of switches K1A, K3A and K4A. Terminal 5 of switches K1A and K4A and terminal 4 of switch K2A are connected to ground 24 via line 54. A varistor RV1 is connected between terminals 3 of switches K1A and K2A, and varistor RV2 is connected between terminals 3 of switches K3A and K4A.

In the off position shown, each of the switches K1A-K4A are shown with terminal 3 connected to contact 4. This basically connects each terminal MT11, MT12, MT21 and MT22 of the motors M1, M2 to ground 24. None of the terminals of the motors M1, M2 are connected to the battery 22. The off state of the relays and contacts K2A and K3A provides a series connection of the motors.

For reverse low speed, relay K4B is turned on, and contacts K4A connect terminals 3 and 5. This connects terminal MT22 of motor M2 via 52 to the plus side of the battery 22. Since the relay K1B and its contact K1A are in their off positions, terminal 3 stays connected to 5, which provides a path 54 to ground 24. Since relays K2 and K3 are off, their contacts K2A and K3A are in the positions shown, which connect the motors M1, M2 in series. This produces the low speed and the reverse connection.

In the forward direction, the relay K1 is on, and the relays K2, K3 and K4 are off. This connects terminal 3 to terminal 4 in K1A connecting it to the battery 22 via 52. This connects terminal MT11 of motor M1 to the positive terminal. K4B remains off connecting terminal 3 to terminal 5 in K4A, whereas terminal MT22 of motor M2 continues to be connected to ground. Since K2A and K3A are in their off positions, the motors remain in series. This produces a low forward speed.

For a forward high speed, relays K1, K2 and K3 are on, and relay K4 is off. The polarity is the same with relays K1 and K4 in the previously described state with K1 having terminals 3 and 4 connected and K4 having terminals 3 and 5 connected. Relays K2 and K4 are on or activated causing their respective terminals 3 to be connected to terminal 4. This places a ground on terminal MT12 of motor M1 and places the battery on terminal MT21 of motor M2 via lead 52. Thus, each of the motors M1 and M2 are connected between battery and ground in parallel in a forward direction.

When the respective on directional polarity switch is at low speed, K1A or K4A is switched to its off position with the terminals 3 and 5 connected, a path to ground is provided for the coils of the motors M1 and M2 in the series connection. This allows the current to go to ground in the reverse direction, thereby producing dynamic braking. In the forward high speed, parallel connection, the switching off of K1A connects terminal 3 to terminal 5. This provides a reverse path for the current in motor M1 (dynamic braking). For dynamic braking of motor M2, switch K3A must be switched off to provide a reverse current path to ground.

Although the positive terminal of battery 22 is connected via lines 38 and 52 to the switches K1-K4, the switches K1 and K2 in their initial off state disconnect the positive terminal of the battery from the terminals MT11, MT12, MT21 and MT22 of the motors M1 and M2. To ensure that the relays and the switches K1-K4 are in their off states, the connection of the power from the battery 12V as 12V RELAY at 34 and to the controller 12V switch at 30 are controlled by the on/off ignition switch 15 and the accelerator switch 16. When the on/off ignition switch 15 is switched on (shown at connector J1), the +12V from the battery through diode D1 is connected via 28 to produce the +12V SWITCH 30 on input pin 9 of the inverter U3. If the switch 15 is not activated, there is no positive reference at U3 and, therefore, all of the leads 2 of the relays K1B-K4B are floating. If the ignition switch 15 is on but the accelerator pedal 16 is not closed, there is no signal 12V RELAY 34 as an input to the switching circuit 50. Thus, there is no positive power to terminals 1 of the relays K1B-K4B.

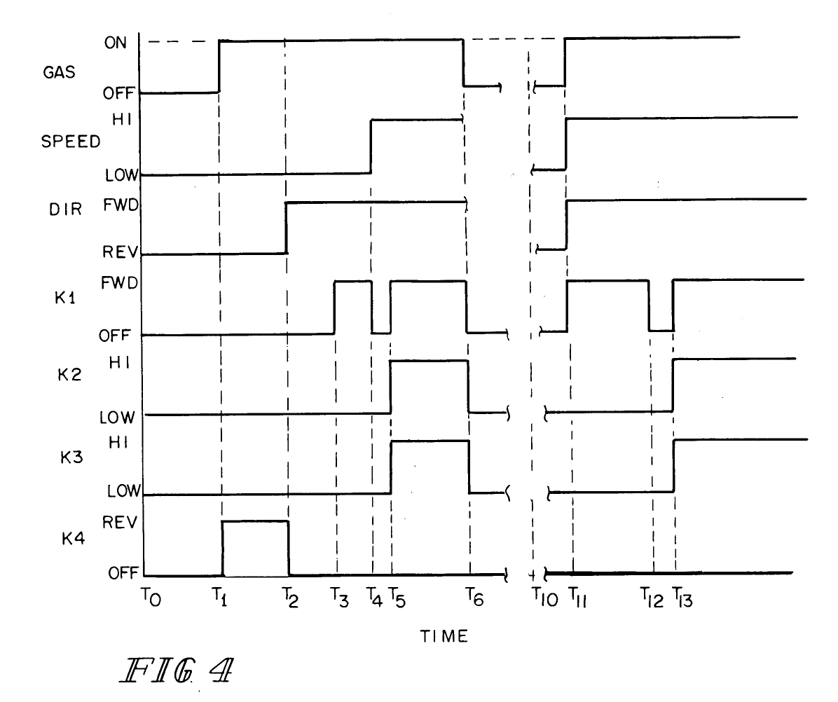

The operation of the system is illustrated in the examples of FIG. 4. The on/off switch 15 and the accelerator 16 in series is illustrated in the first line. The speed is assumed to be “low” for low speed and “high” for high speed. The direction signal will be assumed to be low for reverse and high for forward. The K1-K4 relays are low for off and high for on. The relationship between the motor drives and the relays are as follows:

RELAY STATES

| SPEED/PIN OF MOTORS | K1 | K2 | K3 | K4 |
|---|---|---|---|---|
| OFF | OFF | OFF | OFF | OFF |
| REVERSE LOW SPEED | OF | OFF | OFF | ON |
| FORWARD LOW SPEED | ON | OFF | OFF | OFF |
| FORWARD HIGH SPEED | ON | ON | ON | OFF |

From time T₀ to T₁, the system is off in that one or both of the switches 15 and 16 are open. At T₁, both switches 15, 16 are closed and thus gas is high, the speed is low and the direction is reversed. According to the Table, relays K1, K2 and K3 are off, and relay K4 is on. This maintains the motors in series, and the polarity is determined by K4 connecting the motor terminal MT22 to the battery. This is maintained until T₂ when the direction is changed. For a change of direction, the relay K4 is turned off for a period of time between T₂ and T₃. Since all of the relays K1-K4 are off, the current in the motors' fields is allowed to reverse and, therefore, perform dynamic braking. This reduces the speed of the motors and wheels before the direction is changed. At T₃, the relay K1 is activated connecting terminal MT11 to the battery in a forward direction at low speed.

At T₄, the speed is changed from low to high. With the change of speed, the contact relays K2A and K3A are going to be changed. To reduce any arcing and extend the life the of the relays, K1 and K4 are maintained off, thereby disconnecting the battery from the contacts of the relay. Thus, there is no power on the relay contacts while K2A and K3A are changed. After brief delay at T₅, the relays K2 and K3 are changed to connect the motors in parallel between the battery plus terminal and ground. Also at T₅, relay K1, again, is activated as the forward relay to connect the positive power to terminal MT11 of the first motor. The relays stay in this position until T₆ where the occupant may take their foot off of the accelerator 16. At this point, the relays K1-K4 will return to their off positions.

Another situation is illustrated in the second portion of FIG. 4 at times T₁₀-T₁₃ where the system is started up at high speed. At T₁₁, the on/off switch 15 and accelerator gas switch 16 are closed and thus gas is high, the speed is selected high and the direction is forward. For this condition in the Table, it would require that K1, K2 and K3 be on and K4 be off. But, at T₁₁, only K1 is on, and K2, K3 and K4 are off. This corresponds to the forward low speed condition in the table. This condition is held until T₁₂ when K1 is open disconnecting the power from the series connection of the motors. At T₁₃, after a delay, K2 and K3 are activated changing the motors from series to parallel. Also at T₁₃, K1 is reactivated such that the motors run at high speed in a forward direction. Thus, the full voltage of the battery is applied to the motors initially in series and then, finally, in parallel. This adjustment of the speed prevents a jerky start when the occupant (generally, a child) sets for high speed and then closes switch 16 of the accelerator.

As an alternative to going from high to off when the occupant takes their foot of the accelerator 16 in the forward high speed condition, the controller 40 and more specifically the microprocessor U1 would control the relays K2 and K3 to transition from a high forward speed (parallel connection of the motors M1, M2) to a low forward speed (series connection of the motors M1, M2) before the off position. The microprocessor U1 will determine this transition and label it a deceleration (DECEL in FIG. 5). It is a similar transition as from stop to high forward speed in reverse order.

Another feature of the present system is the over-current protection. As illustrated in FIG. 3, the current sensor 60 is connected to the motors at 62. The current to the motor develops a voltage on resistor R8. This voltage is proportional to the motor current and is filtered by a low pass filter of a resistor R7 and capacitor C10. This voltage is amplified in gain by operational amplifier U4 and resistors R9, R12 and R13. The resulting output voltage is provided via line 64 to pin 3 of the microprocessor U1 which determines the thresholds and exceeding of the thresholds. An appropriate capacitor C9 is provided for the operational amplifiers U4. As an alternative to providing an analog valve to the input 3 of the controlling U1, a pair of comparators like U4 may be used. They would provide high or low signal levels indicating that their respective threshold had been excluded.

As will be discussed with respect to FIG. 5, the controller U1 compares the sensed current to a threshold to determine over-current condition. Since the current through the motors in the low speed or series combination is different than the current through the motors at the high speed or parallel combination, two different thresholds are set. As a typical example, for the low speed, 17.5 amps threshold may be used, and for high speed, twice that or 35 amps threshold could be used.

To alleviate the over-current condition, the controller U1 turns the motors off for a given period of time and then turns them on again. If the over-current condition persists, the motors are again turned off and then on. If this condition exists for a pre-determined number of cycles, the off time of the motors may be increased. The controller V1 may also require the over-current condition exist for a pre-determined amount of time before it turns the motors off. This prevents excessive switching of the contacts on and off. Turning to FIG. 5, the over-current condition for a low speed is illustrated in times T₀-T₈ and at high speed from T₁₁-T₁₇. For ease of illustration, only the forward direction is being illustrated, even though the over-current condition may exist in the reverse direction.

At time T₀-T₂, K1 is turned on selecting the forward direction, and K2-K4 are off. Since it is in the forward direction, K4 will always be off. Also, since it is a low speed, K2 and K3 will also always be off for the example of T₀-T₈. The threshold TH1 is exceeded at T₁ for the low speed threshold, and at a short time later at T₂, the controller 40 switches K1 to its off state. This disconnects power from the motor and allows dynamic braking. At a time T₃, K1 is reactivated. If the over-current exists for the holding period T₃-T₄, the controller 40 again deactivates K1 disconnecting power and dynamic braking the motor. At T₅, the current is reduced below the threshold. At T₆, the controller 40 turns K1 back on connecting the motors in series and in the forward direction. It should be noted that the time period between T₄ and T₆ is the same time period between T₂ and T₃. The motor is run at a low speed in the forward direction until T₇ where the over-current again re-occurs. If this persists for the pre-determined time period between T₇ and T₈, again the relays are turned off, and the motor is dynamically braked.

In times T₁₁-T₁₇, the motor is at a high speed and in the forward direction. K1, K2 and K3 are on, and K4 is off. The threshold TH2 is shown, which is greater than the threshold TH1. At time T₁₁, the current exceeds the threshold TH2, and if this exists for a sufficient amount of time at T₁₂, K1 is switched to its off position disconnecting the motor from power and beginning dynamic braking. After an off time period T₁₂-T₁₃, the motor is turned on again. If the over-current continues for the time period T₁₃-T₁₄, it is turned off at T₁₄. If the over-current condition above threshold TH2 exists for a given number of cycles, the controller 40 lengthens the time of the off cycle. This is illustrated at T₁₅ where the motor is turned off and not turned on again until T₁₆. The period between T₁₅ and T₁₆ is greater than the period between T₁₂ and T₁₃. Again, if the over-current condition exists for a pre-determined amount of time T₁₆-T₁₇, K1 is turned off, and the motors are dynamically braked.

As an example, the on time represents the amount of time the over-current condition must exist, which may be, for example, 5 seconds. The off time in the first series of on/off cycles may be, for example, 10 seconds. If the over-current condition still exists after, for example, five cycles at the 10 second off period, the time period for the second set of cycles T₁₅-T₁₆ can be substantially increased to, for example, 60 seconds. In another example, if after the first off cycle for over current (10 seconds), a second over-current condition occurs for the selected time (5 seconds), the motor drive will be turned off until the foot pedal is released for the off period (10 seconds). The over-current monitoring and duty cycling of the motors help to prevent the motors from overheating (for example, during a stall condition).

The switch of sensor 70 and the modifier controller 40 is illustrated in FIG. 6. Although the current sensor 60 has been deleted from FIG. 6 it may be included therein. FIG. 6 is of those portions that relate to the switch sensor 70 and the modified controller 40 and corresponds to FIG. 3B. Only those elements which operate differently or the additional connections will be described.

The switch sensor 70 is shown as three resistors R20, R21 and R22 connected respectively to the switches K1A, K3A and K4A. They are connected through diodes D5, D6 and D7 in an OR connection. They are provided as an input on line 74 to the controller 40 which includes a process U5 for the switch monitoring and safety control system. Also connected to line 74 is resistor R23 and diode D8. Although only three of the four switches are monitored, the fourth switch K2 may also be monitored into the OR configuration.

Line 74 from the switch sensor 70 is connected on pin 5 of U5. Connected on pin 4 of U5 is the deceleration signal, DECEL, from pin 6 of the microprocessor U1. As discussed above, microprocessor U1 determines a deceleration when the occupant removes their foot from the gas pedal which is sensed on pin 11 of U1; from a high forward speed. U1 drives the switching circuit so that the switches go from parallel to series or high speed to low speed before going to completely off. Line 45, which is the switch gas output of U3 is provided on pin 8 of U5. Connected to pin 7 of U5 is ground and connected to pin 2 is the +5 volts and capacitor C11.

The output on pin 3 of U5 is connected to input pins 6 and 7 of the inverter U3. The corresponding outputs pins 11 and 10 of U3 are connected in an OR to outputs on pins 12 and 13 to control the relays K4B and K3B respectively. The output on pin 3 of U5 is also connected to an FET having a parallel diode D9. The FET and diode D9 are connected to pin 2 of the inverter U3 and connects it to ground when on. This is an OR connection for the relay K2B when the FET is turned on. A high output on pin 15 of U3, turns the relay K2B off.

The decisions made by processor U5 will be described to include the deceleration signal, since the present design of FIG. 6 includes stepping from high to low before going to off. If this deceleration cycle is not included and the system would go directly from high to off, the modification to the logic would eliminate one of the to be described delays.

The processor U5 determines that there is a switch fault if one of the monitored switches K1A, K3A and K4A are on when all the switches are supposed to be off. All the switches are supposed to be in their off positions when the occupant's foot is off the gas pedal, except during deceleration. When the occupant's foot is off the gas pedal, input pin 5 to inverter U3 goes low and provides a high output on pin 12 is an input pin 11 of microprocessor U1. The microprocessor U1 then provides signals on output pins 7, 8, 9 and 10 to pins 1, 2, 3, and 4 of inverter U3. This provides off outputs on pins 13, 14, 15, 16 to relays K1B, K2B, K3B and K4B. Thus the switches K1A, K2A, K3A and K4A should be in their off position as shown with terminal 3 connected to terminal 5. All the connections to the motors would be grounded.

If one of the switches K1A, K3A or K4A is on, terminal 3 is connected to its terminal 4 which is connected to the +12 volt terminal 26. This is sensed by one of the resistors R20, R21, R22 and diode D5, D6, and D7. This provides a high voltage input on pin 5 of U5.

U5 determines whether the gas pedal off high signal on pin 3 of U5 and one of the monitored switches is on (high signal on pin 5 of U5) at the same time. If U5 determines that the gas pedal is off and one of the monitored switch is on, it waits a predetermined time for example 250 milliseconds. This is to make sure that one of the switches KA1, KA3 of KA4 is on and that this is not just a momentary occurrence.

If the gas pedal is off and the monitored switch is on, then U5 determines whether it is in deceleration mode or a DECEL signal is on pin 4. If it is in deceleration, relays K1 should be activated for a short period of time since it is in a low forward, series configuration. U5 would then wait for a predetermined amount of time to allow the deceleration to occur and then checks the conditions on pins 3 and 5 again. This waiting time may be for example 700 milliseconds. If the gas pedal is off and one of the monitored switches is on, after deceleration U5 declares a fault.

A U5 declared fault provides a high output on pin 3. This provides a high input on pins 6 and 7 of inverter U3 which provides a low output on pins 11 and 10 which grounds the relays K3B and K4B. This turns on the switches K3A and K4A such that their terminal 3 is connected to terminal 4. This provides a high on both terminals of motor M2 and therefore the motor does not operate. The high output on pin 3 of U5 indicating a fault also turns on the FET grounding the input to SER/PAR RELAY 1 of pin 2 of inverter U3. The output pin 15 of U3 then provides a high to K2B which turns switch K2A off. This would drive K2A to its off position as shown with terminal 3 connected to terminal 5. If K1 and K2 are in their off position, as shown, motor M1 is off with both of its terminals grounded. If K1A is stuck on, terminal 3 is connected to terminal 4 which is connected to the 12 volts. Terminal 5 of K1A is floating, since K2A is to be in its off position with its terminal 3 connected to its terminal 5 and since K3 is on terminal 5 floating.

After a pre-selected amount of time for example in one second, U5 turns switches K3A and K4A off. After a delay of for example 20 milliseconds, U5 again tests to see if any of the relays were on since they are all supposed to be in the off position. If U5 then senses that one of the monitored switches is again in its on position and the gas pedal is still off, U5 will cycle through the process again of turning switches K3A and K4A on for the preset amount of time and then turning them off. After the predetermined number of cycles, for example eight, switches K3A and K4A are kept on continuously to keep the motors off.

If the deceleration from high through low to zero is not part of the control of the microprocessor U1, the step of determining where it is in deceleration, and delaying the recheck of the switches is eliminated. Also, if one is concerned about a double switch failure, K2A may also be monitored and appropriate correction made to control all the switches K1A, K2A, K3A and K4A.

The over-current protection and switch monitoring are added features and one or both may not be provided if not desired.

Although the present disclosure has been described and illustrated in detail, it is to be clearly understood that this is done by way of illustration and example only and is not to be taken by way of limitation. The scope of the present disclosure is to be limited only by the terms of the appended claims.

1. A ride-on toy vehicle comprising:
an on/off input device, and a direction and speed input device;
a pair of electrical motors connected by a switching circuit to a battery a) in parallel or in series based on a speed input from the direction and speed input device and b) in a first or second polarity based on a direction input from the direction and speed input device;
an electrical controller for receiving the speed input and the direction input and providing switching outputs to the switching circuit;
the switching circuit including four switches each having a separate relay coil and whose positions are controlled by the switching outputs of the controller, first and second switches being connected to the terminals of a first motor and third and fourth switches being connected to the terminals of a second motor;
the first and fourth switches in combination connect the first and second motors to the battery in a first polarity for forward and in a second polarity for reverse; and
the second and third switches connect the first and second motors in parallel for high speed and in combination connect the first and second motors in series for low speed.

2. The vehicle of claim 1, wherein the first switch is on and connected to the battery and the fourth switch is off and connected to ground for the first polarity; and the fourth switch is on and connected to the battery and the first is off and connected to ground for the second polarity.

3. The vehicle of claim 1, wherein the second switch and the third switch in an off position determine the series connection and in an on position determine the parallel connection.

4. The vehicle of claim 1, wherein when the four switches are in an off position, the battery is disconnected from the motors, and the motors are connected to ground.

5. The vehicle of claim 1, including an accelerator input device connected in series with the on/off input device between the battery and the relay coils; and both the accelerator and on/off input devices must be activated for the relays to be operable.

6. The vehicle of claim 5, including a switch sensor connected to the controller and to at least three of the four switches for sensing the on/off state of the at least three switches; and the controller provides switching signals to switch the at least three switches to an off state and determines a fault if the sensed state of any of the at least three switched is an on state.

7. The vehicle of claim 6, wherein the controller, upon determining a fault, provides switching signals to switch at least one of the switches to an on state so as the motors are off.

6. The vehicle according to claim 1, wherein the controller provides switching signals to switch the switching circuit to connect the motors first in series and then in parallel for a change of input from a zero speed to a high speed input and to connect the motors first in series and then off for a change of input from a high speed to a zero speed input.

7. The vehicle of claim 1, wherein the controller switches the switching circuit to an off state for a predetermined period before changing the polarity of the switching circuit in response to a change of direction input from the direction input device.

8. The vehicle of claim 1, including a current sensor for sensing the current in the motors and providing the sensed current to the controller; and the controller provides switching signals to switch the switching circuit to an off state for an over-current value of the sensed motor current.

9. The vehicle of claim 8, wherein the controller provides switching outputs to cycle the switching circuit between off and on states until the over-current subsides or a predetermined number of cycles.

10. A ride-on toy vehicle comprising:
an on/off input device, a direction and speed input device;
a pair of electrical motors connected by a switching circuit to a battery a) in parallel or in series based on a speed input from the direction and speed input device and b) in a first or second polarity based on a direction input from the direction and speed input device;
an electrical controller for receiving the speed input and the direction input and providing switching outputs to the switching circuit; and
the switching circuit in an off state disconnecting the motors from the battery and connecting the motors to ground for a deactivation state of the on/off input device.

11. The vehicle of claim 10, including an accelerator input device connected in series with the on/off input device between the battery and the switching circuit; and both the accelerator and on/off input devices must be activated for the switching circuit to be responsive to switching outputs from the controller.

12. The vehicle of claim 10, including a current sensor for sensing the current in the motors and providing the sensed current to the controller; and the controller providing switching signals to switch the switching circuit to the off state for an over-current value of the sensed motor current.

13. The vehicle of claim 12, wherein the controller provides switching outputs to cycle the switching circuit between off and on states until the over-current subsides or a predetermined number of cycles.

14. The vehicle of claim 12, wherein an over-current value for the series connection of the motors is lower than an over-current value for the parallel connection of the motors.

15. The vehicle of claim 10, wherein the switching circuit including four switches whose positions are controlled by the switching outputs of the controller; switches one and two being connected to the terminals of a first motor and switches three and four being connected to the terminals of a second motor; and in the off state each switch is connected to ground.

16. The vehicle of claim 15, wherein the first switch and the fourth switch in combination determine the polarity and the second switch and the third switch in combination determine the parallel/series connection.

17. The vehicle of claim 15, wherein the four switches each are part of a separate relay.

18. The vehicle of claim 10, wherein the controller switches the switching circuit to the off state for a predetermined period before changing the polarity of the switching circuit in response to a change of direction input from the direction input device.

19. A ride-on toy vehicle comprising:
a direction and speed input device;
a pair of electrical motors connected by a switching circuit to a battery a) in parallel or series based on a speed input from the direction and speed input device and b) in a first or second polarity based on a direction input from the direction and speed input device;
an electrical controller for receiving the speed input and the direction input and providing switching outputs to the switching circuit;
the switching circuit in an off state disconnecting the motors from the battery,
a current sensor for sensing the current in the motors and providing the sensed current to the controller; and
the controller providing switching signals to switch the switching circuit to the off state for an over-current value of the sensed motor current.

20. The vehicle of claim 19, wherein the controller provides switching outputs to cycle the switching circuit between off and on states until the over-current subsides or a predetermined number of cycles.

21. The vehicle of claim 20, wherein the off period of the cycle is increased if the over-current persists for a pre-selected number of cycles.

22. The vehicle of claim 20, wherein the over-current must exist for a pre-selected period before the controller starts the cycle.

23. A ride-on toy vehicle comprising:
an accelerator input device, a direction and speed input device;
a pair of electrical motors connected by a switching circuit to a battery a) in parallel or series based on a speed input from the direction and speed input device and b) in a first or second polarity based on a direction input from the direction and speed input device;
an electrical controller for receiving the speed input and the direction input and providing outputs to the switching circuit; and
the controller providing switching signals to switch the switching circuit to connect the motors first in series and then in parallel for a change of input from a zero speed to a high speed input and to connect the motors first in series and then off for a change of input from a high speed to a zero speed input.

26. A ride-on toy vehicle comprising:
a direction and speed input device;
a pair of electrical motors connected by a switching circuit to a battery a) in parallel or in series based on a speed input from the input device and b) in a first or second polarity based on a direction input from the input device;
an electrical controller for receiving the speed input and the direction input and providing switching outputs to the switching circuit;
the switching circuit including four switches each having a separate relay coil and whose positions are controlled by the switching outputs of the controller, first and second switches being connected to the terminals of a first motor and third and fourth switches being connected to the terminals of a second motor;
a switch sensor connected to the controller and to at least three of the four switches for sensing the on/off state of the at least three switches; and
the controller providing switching signals to switch the at least three switches to an off state and determines a fault if the sensed state of any of the at least three switched is an on state.

27. The vehicle of claim 26, wherein the controller, upon determining a fault, provides switching signals to switch at least one of the switches to an on state so as the motors are off.

28. The vehicle of claim 26, wherein the controller, upon determining a fault, provides switching signals to switch two of the at least two switches to an on state.
